(19) United States
(12) Patent Application Publication
(10) Pub. No.: US 2013/0151519 A1
(43) Pub. Date: Jun. 13, 2013

(54) Ranking Programs in a Marketplace System

(71) Applicants: Marat K. Akhin, Saint Petersburg (RU); Nikolai Tillmann, Redmond, WA (US); Michal J. Moskal, Seattle, WA (US); Jonathan Paul de Halleux, Seattle, WA (US); Manuel A. Fahndrich, Seattle, WA (US)

(72) Inventors: Marat K. Akhin, Saint Petersburg (RU); Nikolai Tillmann, Redmond, WA (US); Michal J. Moskal, Seattle, WA (US); Jonathan Paul de Halleux, Seattle, WA (US); Manuel A. Fahndrich, Seattle, WA (US)

(73) Assignee: MICROSOFT CORPORATION, Redmond, WA (US)

(21) Appl. No.: 13/313,032

(22) Filed: Dec. 7, 2011

(51) Int. Cl. G06F 17/30

(52) U.S. Cl. 707/737; 707/749; 707/740; 707/E17.069; 707/E17.089

(57) ABSTRACT

A marketplace system is described herein for ranking programs based, at least in part, on the assessed distinctiveness of the programs. In one implementation, the marketplace operates by: (a) accessing a set of programs; (b) extracting feature information from each of the programs; (c) generating similarity information for each program, based on the feature information; (d) ranking the programs based at least on the similarity information, to provide ranking information; and (e) providing a user interface presentation that has an effect of promoting at least one distinctive program in the set of applications on the basis of the ranking information.

### BACKGROUND

Users are increasingly relying on mobile computing devices to run programs, instead of (or in addition to) the execution of the programs on traditional personal computing devices. Common examples of these types of mobile computing devices include smartphones, tablet-type computing devices, handheld game devices, electronic book-reader devices, and so on.

In a popular business model, a central repository stores programs that can be executed by the mobile computing devices. In operation, a user can visit the central repository, review the available programs, and then selectively download one or more programs that interest the user. This type of central repository is referred to herein as a marketplace system.

More specifically, the marketplace system can present a variety of tools that allow a user to discover programs of potential interest. For example, a marketplace system can allow a user to specify a key term that is associated with a desired program. The marketplace system can then identify programs which are relevant to the specified term, e.g., by providing textual descriptions of the identified programs. The marketplace system can also provide rating information associated with the programs. In some cases, a moderator associated with the marketplace system can manually provide the rating information for the programs. Alternatively, end users who have presumptively used the programs can provide manual evaluations; the rating information can be derived based on those manual evaluations.

The above-summarized technique for exploring available programs in a marketplace system has potential shortcomings which are set forth in the following explanation.

### SUMMARY

A marketplace system is described herein for ranking programs based, at least in part, on the assessed distinctiveness of the programs. In one implementation, the marketplace operates by: (a) accessing a set of programs; (b) generating similarity information for each program that reflects a relative distinctiveness of each program with respect to other programs in the set of programs; (c) ranking the programs based at least on the similarity information, to provide ranking information; and (d) providing the ranking information to a user.

By virtue of the above-summarized approach, the marketplace system can effectively alert the user to the existence of interesting programs provided by the marketplace system. In one environment, for instance, the approach can bring to the fore interesting programs within a potentially large corpus of programs. The large corpus of programs may contain a relatively large number of similar derivative-type programs that, without the ranking solution presented herein, can have the effect of “burying” the interesting programs.

According to one illustrative aspect, the marketplace system can generate similarity information by grouping the set of programs into a plurality of clusters, based on feature information extracted from the programs. Each plural-membered cluster contains two or more programs that are assessed as being similar to each other. Any technique can be used to form the clusters, such as, without limitation, a locality sensitive hashing (LSH) technique.

According to another illustrative aspect, the marketplace system can perform the ranking by assigning a ranking score to each of the programs in the set of programs. The ranking score may be based, at least in part, on a size of a cluster to which each program belongs. For example, in one environment, a program in a smaller cluster may receive a more favorable ranking score than a program in a larger cluster. The marketplace system can also take into account one or more supplemental ranking factors when generating a ranking score.

According to another illustrative aspect, the ranking operation can also involve removing at least one program in a set of programs based on at least one removal consideration.

The above approach can be manifested in various types of systems, components, methods, computer readable media, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative marketplace system that ranks programs based, at least in part, on the similarity of the programs to each other.

FIG. 2 shows an illustrative environment in which users may access the marketplace system of FIG. 1.

FIG. 3 shows an illustrative implementation of a program selection module, which is a component of the marketplace system shown in FIG. 1. The program selection module includes a program formulation module, a similarity analysis module, and a ranking module.

FIG. 4 illustrates one illustrative technique that the program formulation module (of FIG. 3) can use to extract feature information from a set of programs.

FIG. 5 shows one illustrative data structure that the similarity analysis module (of FIG. 3) can use to group the programs into a plurality of clusters.

FIG. 6 shows one illustrative implementation of the ranking module of FIG. 3.

FIG. 7 graphically depicts the selection of representative programs from a plurality of respective clusters (which is a function that may be performed by the ranking module of FIG. 6).

FIG. 8 shows an illustrative user interface presentation that may be provided by the marketplace system of FIG. 1.

FIG. 9 is a flowchart that shows an overview of one manner of operation of the marketplace system of FIG. 1.

FIG. 10 is a flowchart that shows one manner of operation of the program formulation module of FIG. 3.

FIG. 11 is a flowchart that shows one manner of operation of the similarity analysis module and the ranking module of FIG. 3.

FIG. 12 shows illustrative computing functionality that can be used to implement any aspect of the features shown in the foregoing drawings.

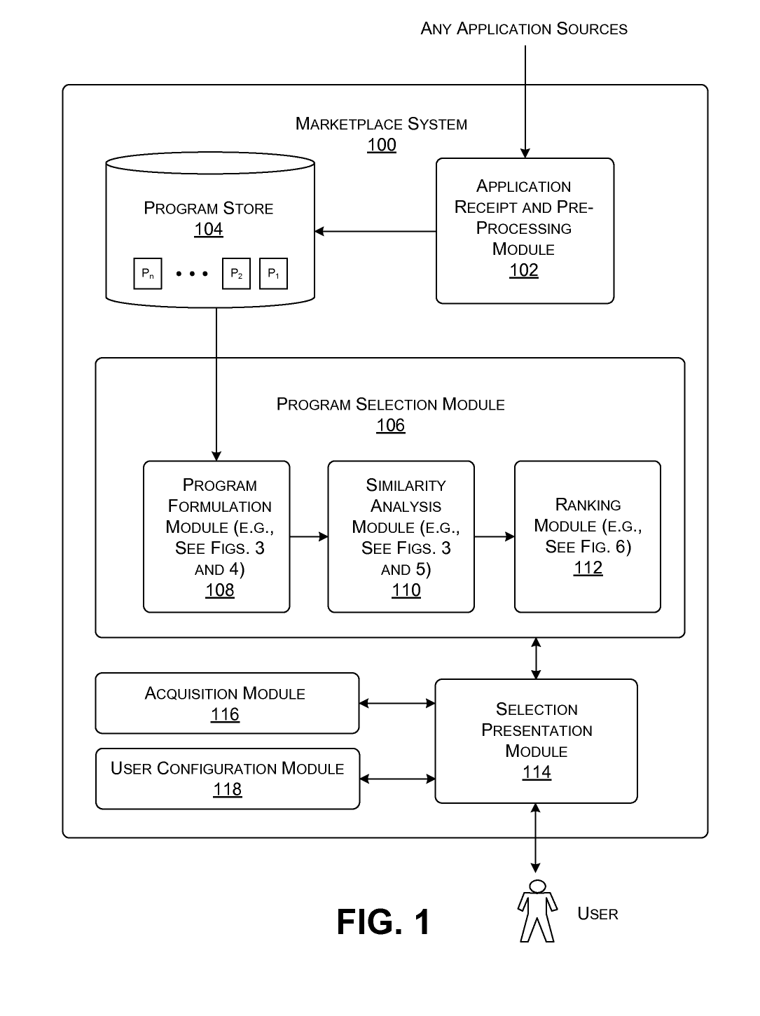

The same numbers are used throughout the disclosure and figures to reference like components and features. Series 100 numbers refer to features originally found in FIG. 1, series 200 numbers refer to features originally found in FIG.

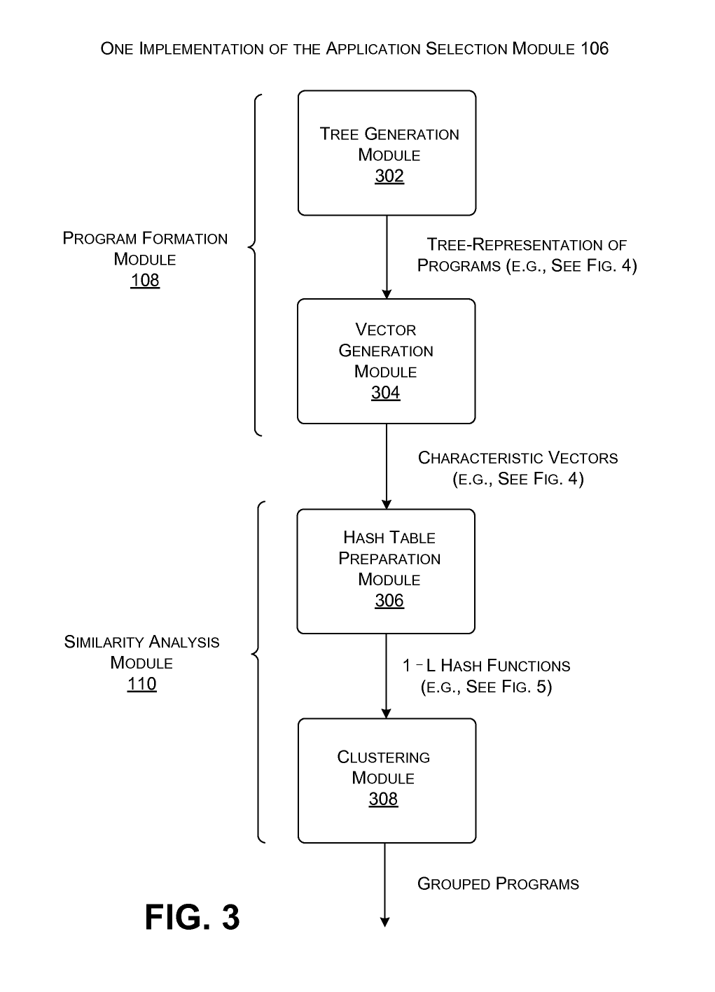

2, series 300 numbers refer to features originally found in FIG. 3, and so on.

### DETAILED DESCRIPTION

This disclosure is organized as follows. Section A describes illustrative marketplace functionality for ranking programs. Section B describes illustrative methods which explain the operation of the marketplace functionality of Section A. Section C describes illustrative computing functionality that can be used to implement any aspect of the features described in Sections A and B.

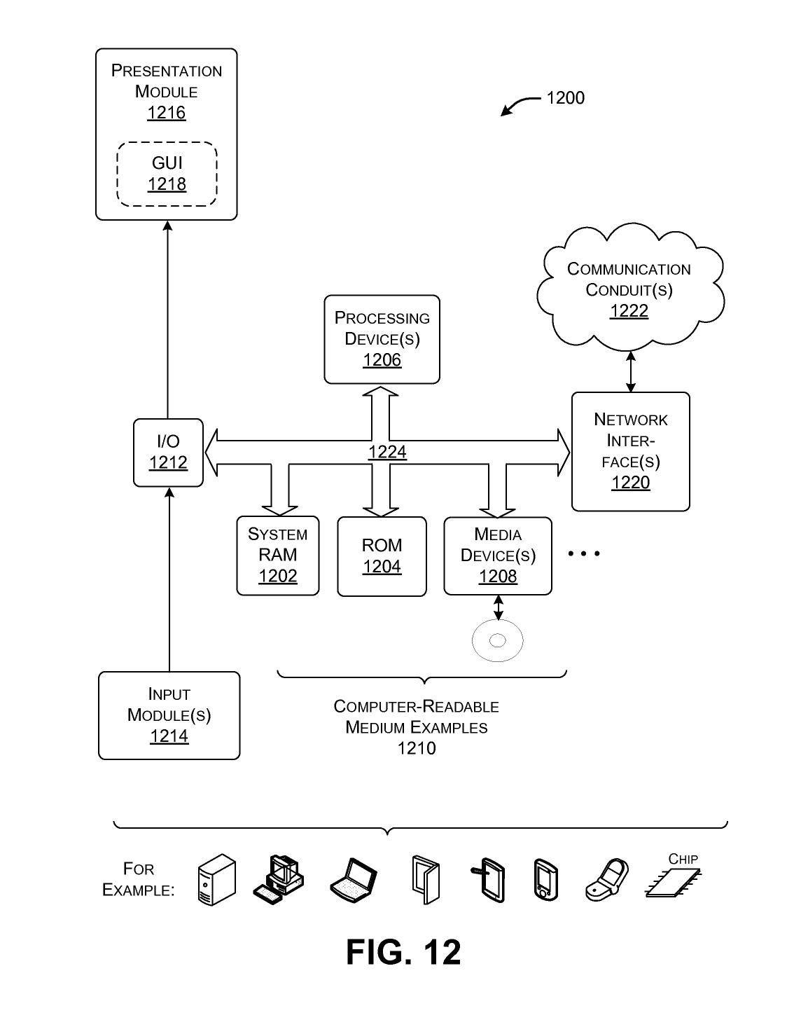

As a preliminary matter, some of the figures describe concepts in the context of one or more structural components, variously referred to as functionality, modules, features, elements, etc. The various components shown in the figures can be implemented in any manner by any physical and tangible mechanisms, for instance, by software, hardware (e.g., chip-implemented logic functionality), firmware, etc., and/or any combination thereof In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. FIG. 12, to be discussed in turn, provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner by any physical and tangible mechanisms, for instance, by software, hardware (e.g., chip-implemented logic functionality), firmware, etc., and/or any combination thereof

As to terminology, the phrase “configured to” encompasses any way that any kind of physical and tangible functionality can be constructed to perform an identified operation. The functionality can be configured to perform an operation using, for instance, software, hardware (e.g., chip-implemented logic functionality), firmware, etc., and/or any combination thereof

The term “logic” encompasses any physical and tangible functionality for performing a task. For instance, each operation illustrated in the flowcharts corresponds to a logic component for performing that operation. An operation can be performed using, for instance, software, hardware (e.g., chip-implemented logic functionality), firmware, etc., and/or any combination thereof When implemented by a computing system, a logic component represents an electrical component that is a physical part of the computing system, however implemented.

The phrase “means for” in the claims, if used, is intended to invoke the provisions of 35 U.S.C. §112, sixth paragraph. No other language, other than this specific phrase, is intended to invoke the provisions of that portion of the statute.

The following explanation may identify one or more features as “optional.”This type of statement is not to be interpreted as an exhaustive indication of features that may be considered optional; that is, other features can be considered as optional, although not expressly identified in the text. Finally, the terms “exemplary” or “illustrative” refer to one implementation among potentially many implementations

A. Illustrative Mobile Device and its Environment of Use

FIG. 1 shows marketplace system 100 that includes functionality for allowing users to review and access a set of programs. In one case, a user may download a program for use on a mobile computing device, such as, but not limited to, a smartphone, an electronic book-reader device, a tablet-type computing device, a laptop computing device, a personal digital assistant device, a portable game device, a vehicle-borne computing device, and so on. Alternatively, or in addition, a user can download a program for use on a traditionally stationary computing device, such as a personal computing device, a game console device, a set-top box, and so forth. The term “user computing device” encompasses the use of any type of computing device to access the marketplace system, whether mobile or stationary.

The marketplace system 100 can allow users to access programs based on any business paradigm. For example, in some cases, the marketplace system 100 can allow a user to download a program upon payment of an identified fee. In other cases, the marketplace system 100 can allow a user to download a program free of charge. Moreover, the marketplace system 100 can provide access to a program in any manner. In the preceding explanation, the marketplace system is said to allow a user to download a program, whereupon the program runs on a user's computing device. In another case, the marketplace system 100 can allow a user to access and run a program at a remote location (e.g., at the marketplace system 100 itself), that is, without necessarily downloading it.

The marketplace system 100 can receive programs from any source or combination of sources. In some cases, the marketplace system 100 can receive programs from respective professional program developers. Alternatively, or in addition, the marketplace system 100 can receive programs that have been developed by “ordinary” end users. For example, Microsoft Corporation® of Redmond, Washington, provides a program development framework, named TouchDevelop, that allows users to author programs on their respective mobile computing devices (such as their smartphones). After creation, the users may run these programs on their user computing devices. In addition, or alternatively, the users can forward these programs to the marketplace system 100, e.g., with the intention of making these programs available for other users to review and obtain.

The TouchDevelop framework uses a statically typed programming language that takes its traits from imperative, object-oriented and functional paradigms. Further, the TouchDevelop framework provides an interface that allows a user to create the programs by successively choosing program statements (rather than typing the statements out, character by character). More specifically, in some cases, a user may create a completely original program by specifying that program from “scratch” in statement-by-statement fashion. In other cases, a user may produce a derivative program by first accessing an existing program, and then modifying that program in any manner. Indeed, in certain environments, a relatively large number of users may choose to create such derivative programs, e.g., due to the ease at which they can be created. As a consequence, the marketplace system 100 may potentially store a relatively large number of programs that differ from each other in relatively minor ways. And some programs may be identical to each other.

The marketplace system 100 described herein provides functionality for effectively managing a large number of programs, including the above-described types of closely-related derivative programs. To better appreciate the merits of the solution presented herein, first consider representative problems that may be posed by the storage of a large number of closely-related programs. For example, suppose that a user visits the marketplace system 100 to find a program that performs a certain function (such as a program that performs the function of sorting of audio files). Without the solution presented herein, the marketplace system 100 may reveal a relatively large number of programs that perform this basic function. For example, these programs may represent minor variations of an original program, created by an original author. Confronted with such a large number of similar programs, a user may have difficulty in determining which program to select from a group of closely-related programs.

In another scenario, a user may not be attempting to find a target program that performs a certain function; rather, the user may wish to peruse new programs that have been uploaded, e.g., to determine whether any of these programs piques his or her interest. But again, without the solution presented herein, the marketplace system 100 may inundate the user with a relatively large number of programs that differ from each other in relatively minor ways. The user may have difficulty in picking out distinct programs from an undifferentiated mass of similar programs. Effectively, without the solution presented herein, the marketplace system 100 may have the effecting “burying” the interesting programs. In any event, the marketplace system 100 can be expected to deliver a poor user experience to the user in the above-described circumstances.

As stated above, the above-described issues may arise in a marketplace system that provides programs created by the TouchDevelop framework. But the principles set forth herein can be applied to any marketplace system that stores programs created in any manner and by any development framework. For example, the above-described issues may also arise with respect to programs created by professional program developers using any program language.

With the above introduction, the components shown in FIG. 1 will now be described in a generally top-down manner. To begin with, an application receipt and pre-processing module 102 (“receipt module” 102, for brevity) can receive programs from any source or combination of sources identified above. For example, the receipt module 102 can receive such programs from one or more remote sources via electronic transfer over any network or combination of networks. The remote sources may correspond to developer systems, individual computing devices used by end users, and so on. The receipt module 102 can also optionally perform any preliminary vetting of the programs that it receives, such as by determining whether the programs pose security risks.

The programs that are received can perform any high-level function, such as managing media resources, conducting web searches, performing calculations in various end-use environments, and so on. In addition, or alternatively, at least some programs can perform lower-level resource-management functions. Each program can be implemented in any manner, such as by executable code, script content, markup language content, and so on, or any combination thereof

The receipt module 102 can store the programs that it receives in a program store 104. The program store 104 is designated as a single repository for convenience, but it can actually represent one or more repositories provided at one location or distributed over plural locations.

A program selection module 106 ranks a set of programs provided in the program store 104. As used here, the term “ranks” has broad connotation. Generally stated, the program selection module 106 ranks the programs by selectively highlighting (e.g., promoting) certain programs relative to other programs in the set of the programs. The ultimate objective in doing so is to bring to the fore programs that may interest a particular user who visits the marketplace system 100. In some cases, for instance, the program selecting module 106 operates to identify programs that are distinctive or uncommon, meaning programs that differ from other programs in the set of programs in significant ways.

In one case, the program selection module 106 can selectively promote programs by ordering the programs based on similarity information, among other potential ranking factors. As will be described below, the similarity information identifies the degree of relatedness among the programs. By gauging how similar a program is with respect to other programs, the similarity information also reflects the relative distinctiveness of the program with respect to other programs. In addition, or alternatively, the program selection module 106 can selectively promote programs by removing some of the programs from the set of programs; this prevents the marketplace system 100 from alerting a user as to the existence of these removed programs. In any event, the output of the program selection module 106 is said to constitute ranking information, according to the terminology used herein. The ranking information can convey the outcome of whatever selective promoting has been performed by the program selection module 106.

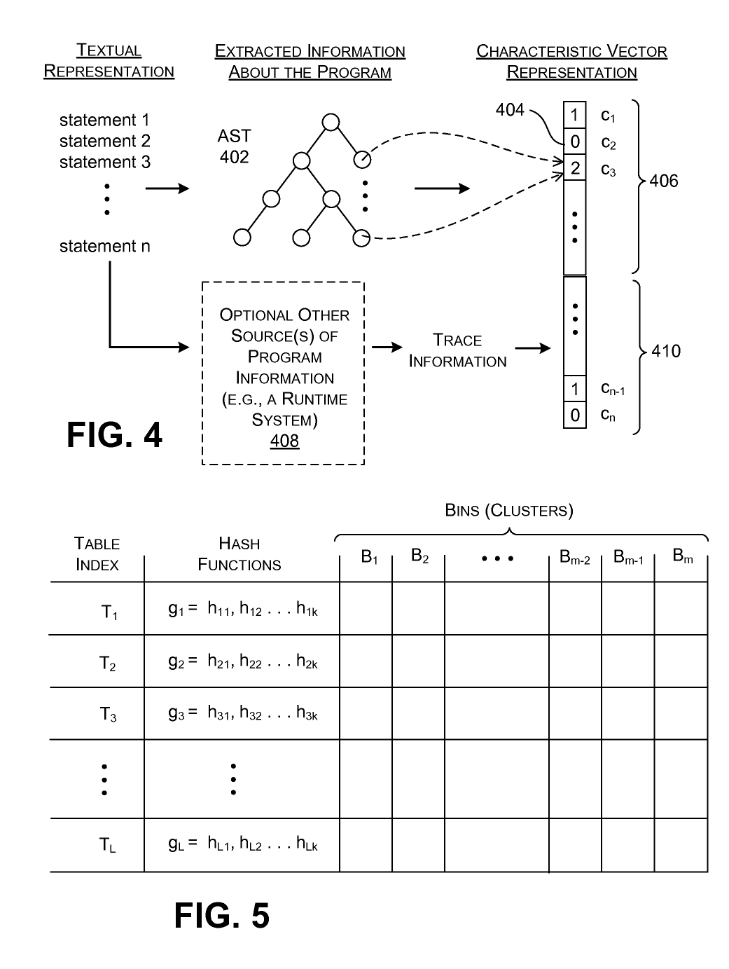

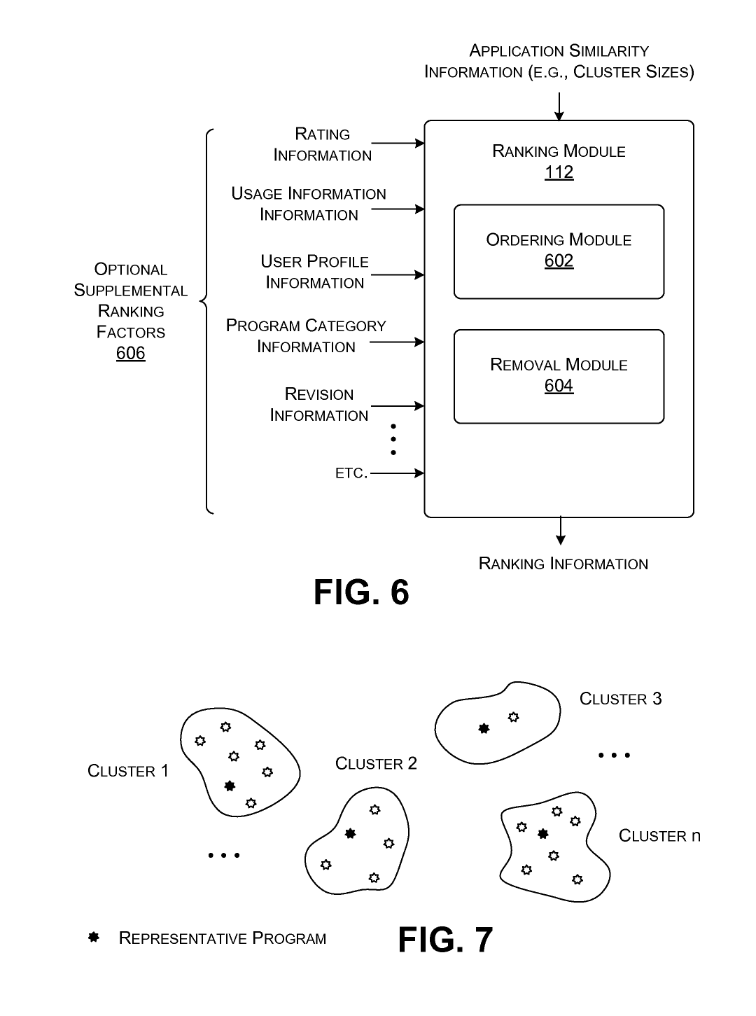

The program selection module 106 includes (or can be conceptualized as including) three component modules: a program formulation module 108; a similarity analysis module 110; and a ranking module 112. The program formulation module 108 operates by extracting feature information from the programs in the set of programs. Additional information regarding this module is provided in the context of the description of FIGS. 3 and 4 below. The similarity analysis module 110 operates by generating similarity information for each program, based on the feature information. Additional information regarding this module is provided in the context of the description of FIGS. 3 and 5. The ranking module 112 operates by generating ranking information based on the similarity information, in conjunction with one or more optional additional ranking factors. Additional information regarding this module is provided in the context of the description of FIGS. 6 and 7.

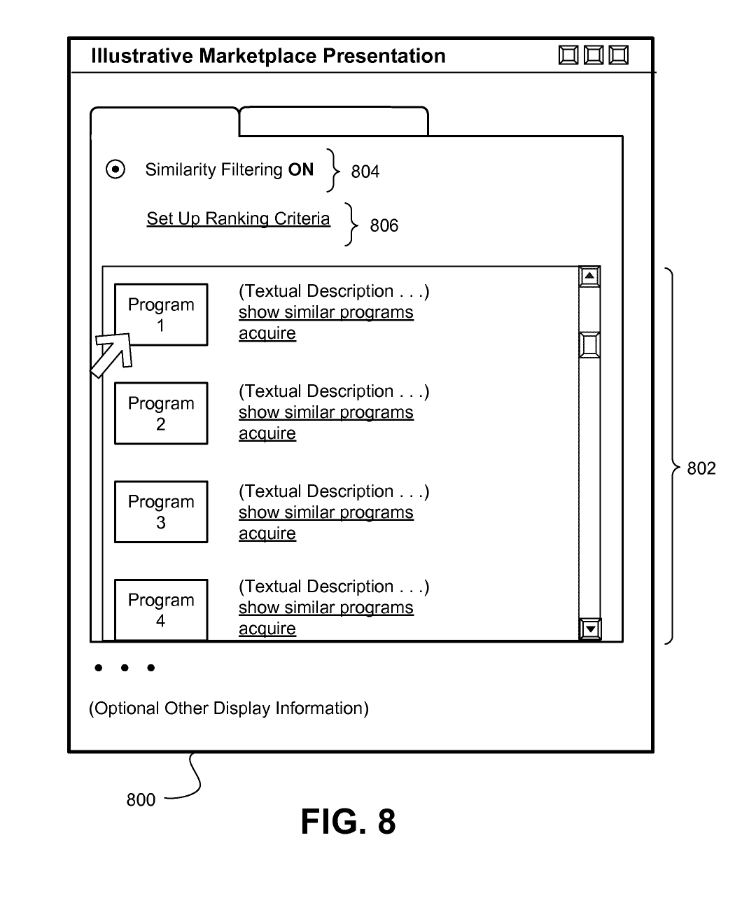

A selection presentation module 114 operates by presenting one or more user interface presentations to a user when the user accesses the marketplace system 100. The user interface presentations convey the results of the ranking performed by the program selection module 106. For example, the selection presentation module 114 can display a list of programs that have been ordered by the program selection module 106, omitting (or otherwise deemphasizing) any programs that have been removed by the program selection module 106. Alternatively, or in addition, the selection presentation module 114 can convey the results of its ranking in other formats, such as via an Email message, an instant messaging (IM) message, an SMS message, a message posted or disseminated via a social networking service, a downloadable file expressed in any format, and so on. Additional information regarding this module is provided in the context of the description of FIG. 8 below.

An acquisition module 116 provides functionality that allows a user to select and acquire any program identified by the selection presentation module 114. For example, in a first case, a user may acquire a program by downloading it. In a second case, a user may acquire a program by gaining rights to utilize it, but without otherwise physically acquiring a local copy of it. The acquisition module 116 can govern access to programs based on any compensation paradigm, and/or by granting access to certain programs (or all programs) free of charge.

A user configuration module 118 allows any user to specify his or her preferences as to the manner in which the program selection module 106 performs its ranking operation. Such preferences, for instance, can control whether or not any ranking is performed. In addition, such preferences can control the relative influence of different ranking factors and removal considerations in the ranking process, e.g., by adjusting weights associated with these factors and considerations. In addition, the preferences can control the manner in which the selection presentation module 114 presents the ranking information to the user in the context of one or more user interface presentations.

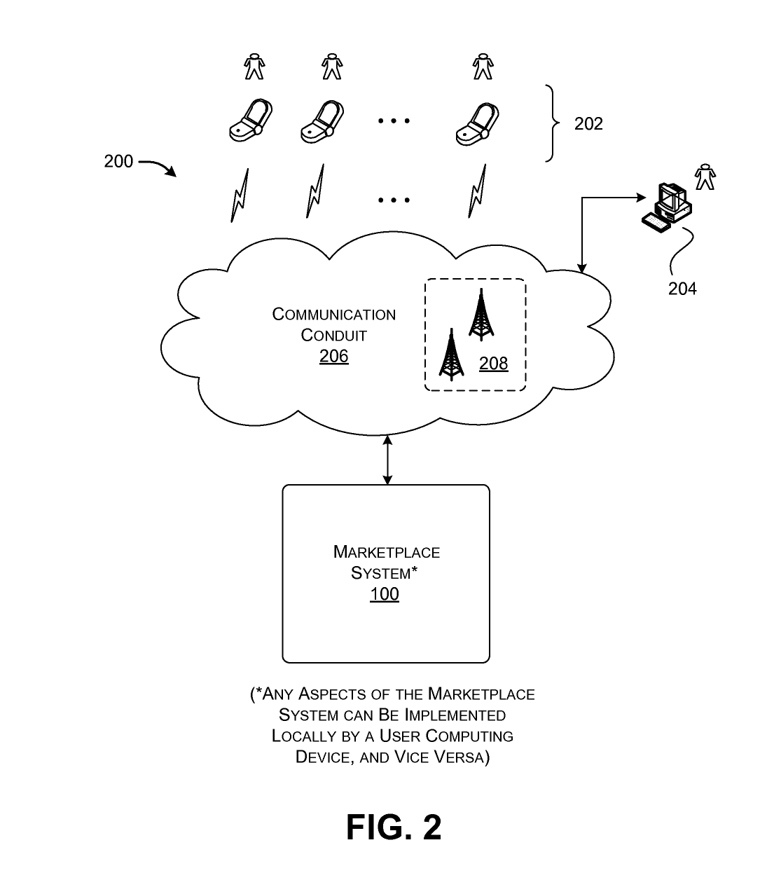

FIG. 2 shows an illustrative environment 200 in which users may access the marketplace system 100 using a collection of respective mobile computing devices 202. Any mobile computing device may represent any type of computing functionality that has the capability of communicating with a remote entity via wireless communication. For example, any mobile computing device may represent any type of portable devices identified above (such as smartphones, etc.). Alternatively, or in addition, the user can access the marketplace system 100 using any type of traditionally stationary computing device having a wireless and/or wired communication interface, such as a personal computer, a game console device, a set-top box device, and so forth. FIG. 2 depicts one such illustrative user computing device 204.

A communication conduit 206 couples the user computing devices (202, 204) to the marketplace system 100 (and to other entities). The communication conduit 206 can represent any mechanism or combination of mechanisms that allows the user computing devices (202, 204) to communicate with remote entities (and to communicate with each other). Generally stated, the communication conduit 206 can represent any local area network, any wide area network (e.g., the Internet), or any combination thereof. The communication conduit 206 can be governed by any protocol or combination of protocols.

At least part of the communication conduit 206 can be implemented by wireless communication infrastructure 208. In one case, the wireless communication infrastructure 208 can represent a collection of cell towers, base stations, satellites, etc. The wireless communication infrastructure 208 can be administered by one or more wireless communication providers. The communication conduit 206 can also include wired network infrastructure.

In one implementation, the marketplace system 100 may represent one or more server computing devices and associated data stores (and/or other electronic equipment). The marketplace system 100 can be implemented at a single site or can be distributed over multiple sites. Further, the marketplace system 100 can be administered by a single entity or by multiple entities. In one implementation, a user can access the marketplace system 100 by using his or her computing device to access its services at a corresponding network address (e.g., a URL).

In another implementation, any individual user computing device can locally implement any function that is described below as being performed by the remote marketplace system 100. In other words, at least some functions of the marketplace system 100 can be distributed between local and remote computing resources. In yet another case, all ranking functions attributed to the marketplace system 100 can, instead, be performed by individual user computing devices.

Advancing to FIG. 3, this figure shows one illustrative implementation of the program formulation module 108 and the similarity analysis module 110. By way of overview, this functionality generates characteristic vectors which characterize a set of programs. The functionality then uses a locally sensitive hashing technique to group the characteristic vectors (and thereby the programs themselves) into respective clusters. However, this technology is cited by way of illustration, not limitation; other techniques can be used to determine feature information and then to assess similarities among the set of programs based on the feature information.

Beginning with the program formulation module 108, a tree generation module 302 can represent each program as an abstract syntax tree (AST). To form such a tree, the tree generation module 302 identifies the syntactical features in the program, such as assignments, loops, if-then-else statements, method calls, etc. In one implementation, the tree generation module 302 can discriminate among different method calls based on the number of arguments in the method calls. The tree generation module 302 can also identify different data types in the program, such as variables and constants. After identifying these various features, the tree generation module 302 can arrange the features into a hierarchal tree. The structure of the program defines the structure of the hierarchical tree. For example, an if-then-else statement in the program may correspond to a branch within the hierarchical tree.

A vector generation module 304 translates the AST for each program into a characteristic vector. The characteristic vector characterizes the AST. For example, in one implementation, the characteristic vector has plural components. Each component corresponds to a particular type of feature that may be present the AST. If the AST does not have any occurrences of a particular feature, the vector generation module 304 can assign the value 0 to the corresponding component of the characteristic vector. Alternatively, if the AST includes n occurrences of the particular type of feature, then the vector generation module 304 will assign the value n to the corresponding component of the characteristic vector.

More specifically, in one case, each node in the AST corresponds to a respective feature. The characteristic vector can map the prevalence of each single-node feature in the AST to a corresponding component of the characteristic vector. More generally, the vector generation module 304 can map node patterns of any complexity in the AST to respective components. For example, the vector generation module 304 can map node patterns expressed in sub-trees of height y (having y levels) to distinct components in the characteristic vector. If y=1, the vector generation module 304 reverts to the first-stated example, e.g., by mapping single nodes to associated components in the characteristic vector.

Advancing momentarily to FIG. 4, this figure graphically depicts an example of the operations set forth above. In this example, the tree generation module 302 generates an AST 402. More specifically, the tree generation module 302 can receive a program in any form, such as source code form, executable form, and so on. In that original state, the program may comprise a plurality of statements that can be expressed in textual form. The tree generation module 302 then transforms this original program into an AST 402, e.g., by assigning different features in the program to nodes in the AST 402. The vector generation module 304 then translates that AST 402 into a characteristic vector 404 having a plurality of components 406 (e.g., c₁, c₂, c₃ . . . ). Component c₁ has a value of 1, meaning that there is one instance of that particular programmatic feature in the AST 402. Component c₂ has a value 0, meaning that there are no instances of that particular programmatic feature in the AST 402. Component c₃ has a value of 2, meaning that there are two instances of that particular type of programmatic feature in the AST 402. In this example, the components of the characteristic vector correspond to individual kinds of single nodes, but, as stated above, the components can alternatively correspond to different kinds of node patterns of height y.

In the example above, the vector generation module 304 forms a characteristic vector 404 solely on the basis of the syntactical information extracted from the program. Alternatively, or in addition, the vector generation module 304 can obtain other information regarding the program from one or more other sources 408. For example, a runtime system can generate trace information in the course of running the program. The trace information identifies the functions that are activated in the course of running the program. For example, the trace information can identify the APIs and method calls that are invoked in the course of running the program. The vector generation module 304 can then extract features from the trace information and represent those features in corresponding trace-related components 410 of the characteristic vector 404. For example a component of the characteristic vector 404 can indicate how many times a particular API has been invoked in the course of running the program. The vector generation module 304 can mine yet other sources of information regarding any aspect of the program.

Now advancing to the similarity analysis module 110, it is possible to assess the similarity of two programs by directly computing the edit distance between corresponding ASTs associated with the two programs. The edit distance relates to the number of additions, deletions, substitutions, etc. that will, considered all together, transform the first AST into the second AST. Edit distance can be assessed using any metric, such as a Euclidean metric, a Manhattan metric, etc. However, this method of comparison is not feasible when performed on a large scale. To address this issue, the similarity analysis module 110 assesses the similarity of any two programs by determining the similarity between the program's characteristic vectors. More specifically the distance between any two characteristic vectors represents a lower bound on an edit distance between the associated ASTs.

However, it still remains computationally expensive to perform pairwise comparison of characteristic vectors. To address this issue, the similarity analysis module 110 can resort to one or more strategies to accelerate this comparison process. One such strategy is referred to as locality sensitive hashing (LSH). General background information regarding the topic of locality sensitive hashing can be found in, for example, Gionis, et al., “Similarity Search in High Dimensions via Hashing,” Proceedings of the 25^{th} VLDB Conference, 1999, and Andoni, et al., “Near-Optimal Hashing Algorithms for Approximate Nearest Neighbor in High Dimensions,” Communications of the ACM, Vol. 51, No. 1, January 2008.

LSH is based on the observation that, if two points p, q in high-dimensional space are close to each other, then, probabilistically, their projections h(p), h(q) will also be close together. A projection refers to a hash function hₖ selected from a family F of LSH functions, i.e., F={hₖ}, where that those hash functions satisfy the following properties three properties.

(1) If d(p, q)≦R, then Pr[h(p)=h(q)]≧P₁. Property (1) states that, if the distance between points p and p (d(p, q)) is less than or equal to some threshold (R), then the probability that the hash of p (i.e., h(p)) equals the hash of q (i.e., h(q)) is greater than or equal to some value P₁. In the context of the present disclosure, p and q correspond to two characteristic vectors which correspond, in turn, to two respective programs.

(2) If d(p, q)≧cR, then Pr[h(p)=h(q)]≦P₂. Property (2) states that if the distance between points p and p (d(p, q)) is greater than or equal to some threshold (R) multiplied by an approximation factor c, then the probability that the hash of p (i.e., h(p)) equals the hash of q (i.e., h(q)) is less than or equal to some value P₂.

(3) P₁>P₂. Property (3) indicates that P₁ is greater than P₂ in order for the LSH processing to provide useful results.

The probabilistic nature of the above formulation means that there is some chance that the projections h(p), h(q) will not be close together, even though the points p, q themselves are close together. To address this issue, the similarity analysis module 110 can establish and use a k-component hashing function gⱼ that combines k hash functions randomly selected from the family F. In other words, gⱼ=(h₁, . . . hₖ). In some implementations, the application of gⱼ to a particular characteristic vector p yields a result vector R, e.g., R=h₁(p), h₂(p), . . . , hₖ(p); that result vector R can then be used for hash table indexing. In other implementations, the result vector can be converted, using another hash function, into a single value; that single value can then be used for hash table indexing. Moreover, the similarity analysis module 110 can employ L such k-component hashing functions. For example, the first such function can be expressed as g₁=(h₁₁, h₁₂, h₁ₖ). When populated with values, the L k-component hash functions gⱼ produce L corresponding hash tables.

By virtue of the above provisions, the similarity analysis module 110 can ensure that the probability at which the LSH analysis fails is less than or equal to some value δ; this is achieved by setting L equal to:

$$L = [ \frac{\vert log δ \vert}{log ( 1 - {P}_{1}^{k} )} ] .$$

In one implementation, the similarity analysis module 110 chooses the hash functions hₖ from the following LSH function family:

$$h ( v ) = [ \frac{a \cdot v + b}{w} ] .$$

In this expression, a is a vector having components independently selected from a stable distribution, such as a Gaussian distribution N(0, 1). The symbol b refers to a number selected from U(0, w), where w refers to the width of hashing buckets. (The concept of a hashing bucket is described below.)

With the above introductory information, FIG. 3 indicates that the similarity analysis module 110 can include a hash table preparation module 306 and a clustering module 308. The hash table preparation module 306 computes a set of L k-component hash functions, as described above. Each k-component hash function includes a combination of k component hash functions selected from the above-described family F of hash functions.

The clustering module 308 hashes each characteristic vector using each hash function (gⱼ). This operation populates the L hash tables associated with the respective hash functions with values. The results of this hashing also reveal similarities among the programs. For example, consider a characteristic vector v₁ associated with a first program and characteristic vector v₂ associated with a second program. Assume that the application of the hash function g₁ to the characteristic vector v₁ produces a value B. Further assume that the application of the hash function g₁ to the characteristic vector v₂ produces the same value B (and thereby produces a hash collision). By virtue of the properties set forth above, there is a probability that the first characteristic vector v₁ is similar to the second characteristic vector v₂, meaning, in turn, that there is a probability that the first program is similar to the second program. To verify whether the first program is indeed similar to the second program, the similarity analysis module 110 can compute the actual edit distance between the first characteristic vector v₁ and the second characteristic vector v₂. (This comparison can also be performed on the basis of the corresponding ASTs themselves.) If the edit distance is less than a prescribed threshold, then the two programs are indeed similar.

More generally stated, for each hash function the clustering module 308 places the programs in different bins (where a bin corresponds to a particular value that is produced by a k-component hashing function gⱼ). Each bin that includes two or more entries will identify a group of programs that are potentially similar to each other. Hence, each bin can be considered as a respective cluster for that particular gⱼ.

More specifically, the different k-component hash functions can map each program into different respective bins. For example, assume that programs A and B are, in fact, similar to each other. A first k-component hash function (e.g., g₁) can map the programs A and B to a bin X, while a second k-component hash function (e.g., g₂) can map the programs A and B to a bin Y, and so on. Hence, the similarity analysis module 110 can produce multiple sets of clusters, each corresponding to a particular k-component hash function. Nevertheless, to simplify and generalize the description, the similarity analysis module 110 can more loosely be said to group each program into a single cluster. In the case of locality sensitive hashing, the single cluster takes into account the grouping results established by each of the L k-component hash functions, e.g., based on any type of aggregating or summarizing analysis. For example, in the scenario set forth above, one particular cluster can take into account the programs mapped into bins X and Y.

The clusters produced by the similarity analysis module 110 constitute similarity information according to the terminology used herein. The similarity information reveals groups of programs that have a prescribed similarity to each other. The similarity information can also quantify how similar any particular program is to any other program, e.g., by computing the edit distance between the corresponding characteristic vectors or ASTs of the programs.

To repeat, although FIG. 3 shows an implementation that relies on locality sensitive hashing functions, the similarity analysis module 110 can use any other technique to form clusters of similar programs. One such technique is the k-means technique. In still other cases, the program selection module 106 can generate similarity information without first extracting feature information. For instance, the program selection module 106 can order programs based on already-provided metadata pertaining to the programs (that does not need to be extracted).

Advancing to FIG. 6, this figure shows one implementation of the ranking module 112. The ranking module 112 accepts the similarity information provided by the similarity analysis module 110. Based on at least on this information, the ranking module 112 can rank the programs. More specifically, the ranking module 112 can be conceptualized including an ordering module 602 and a removal module 604. The ordering module 602 orders programs into a particular order, or which otherwise selects programs from a larger set of programs. The removal module 604 removes one or more programs from further consideration, e.g., either by physically deleting the programs or by otherwise flagging them in an appropriate manner so that they are not presented to the user when he or she visits the marketplace system 100, or so that they are otherwise deemphasized.

As a result of its processing, the ranking module 112 produces ranking information. The ranking information can convey any instructions to the selection presentation module 114 as to how it is to present a group of candidate programs. For example, the ranking information can provide identifiers associated with the programs that are to be presented, together with ranking scores associated with each of the programs.

Consider the operation of the ordering module 602 in greater detail. The ordering module 602 can assign a ranking score to each program based, in part, on the similarity information. For example, the ordering module can assign a ranking score r to a program based on the equation r=W/|Cₜ|. Here, |Cₜ| correspond to the size of the cluster to which the program belongs, e.g., corresponding to the number of programs in the cluster. The symbol W represents any ranking multiplier that captures additional information about program distinctiveness, such the size of the code file associated with the program in question. In view of its denominator, this equation has the effect of elevating the rank of a program in inverse proportion to the size of the cluster. That is, all other factors being equal, a program that has few similar peers will be ranked higher than a program having a greater number of similar peers. However, other environments can adopt other ways of mapping cluster size to rank, such as by favoring large cluster sizes over small cluster sizes. In one implementation, the ranking module 112 can perform the above-described ranking for only the programs in the m smallest clusters. In another implementation, the ranking module 112 can rank all programs regardless of cluster size.

More specifically, consider the case in which clusters are formed using the locality sensitive hashing technique. As noted above, this technique groups each program into a particular cluster for each of L k-component hashing functions. The ranking module 112 can form a ranking score r for each program for each hashing function, e.g., to yield L such ranking scores for each program. The final ranking score for a program can be computed by forming an average of the L ranking scores for that program, or performing any other type of aggregating or summarizing operation. There is a possibility that a particular hashing function can classify a particular program into the “wrong” cluster, which may result in an anomalous ranking score for that particular hashing function. However, by taking into consideration a suitably large number L of hashing functions, this type of failure can reduced to satisfactory levels.

While the locality sensitive hashing technique uses multiple sets of clusters, to simplify and generalize description, the ranking score r can be described as being computed based on the size of a single cluster to which the program in question belongs. In the particular and non-limiting case of locality sensitive hashing, the single cluster takes into account the grouping results of the L k-component hashing functions. In other techniques, the similarity analysis module 110 can literally compute a single set of clusters, rather than multiple sets of clusters.

The ordering module 603 can also take into consideration a host of other supplemental ranking factors 606 in assigning a ranking score to a program. Without limitation, FIG. 6 enumerates some possible supplemental ranking factors.

One supplemental ranking factor is rating information. Rating information conveys a rating of each program that is manually assigned by one or more users. For example, the rating information can reflect an evaluation made by a moderator or other person associated with the marketplace system 100. Alternatively, or in addition, the rating information can reflect the cumulative (e.g., crowd-sourced) manual evaluations made by a group of end users who have used the program in question. In one implementation, the ranking module 112 can use a high rating score to boost the value of a final ranking score for a particular program.

Another supplemental rating factor is usage information. The usage information conveys a degree of utilization of each program by one or more users. For example, the usage information can indicate how many times that a particular program was downloaded and/or run by users. In one implementation, the ranking module 112 can use a high utilization score to boost the value of a final ranking score for a particular program.

Another supplemental rating factor is user profile information. The user profile information identifies program-related preferences of one or more users. In one case, the user profile information can reflect the prior behavior of a user. For example, the user profile information may indicate that a particular user has frequently downloaded particular types of programs, such as game programs. Alternatively, or in addition, the user profile information can reflect factors that may indirectly relate to user preferences, such as any type of user demographic information. In one implementation, the ranking module 112 can use the user profile information to adjust a final ranking score for a particular program based on the preferences of the user who is currently interacting with the marketplace system 100. For example, if a user enjoys playing games, the ranking module 112 can boost the final ranking score of a game-related program. This also means that marketplace system 100 can deliver different ranking scores to different respective users based on their preferences.

Another supplemental ranking factor is program category information. The program category information identifies the subject matter associated with a particular program. In one implementation, the ranking module 112 can apply the program category information to positivity (or negatively) weight a ranking score of a program based on the subject matter to which the program pertains. This outcome is similar to that described above for the case of user profile information, but the program category information does not take into account the preferences of individual users.

Another supplemental ranking factor is revision information. The revision information can identify the “position” of a program under consideration in a hierarchy of revisions that are linked to the program. For example, in one case, the program in question may represent a first version of the program, there being no pre-existing counterparts to the program. In other cases, the program may represent a later revision of some earlier-created program. Indeed, in some cases, the program may represent the latest revision of the program in chain of such revisions. The ranking module 112 can apply the revision information by adjusting a final ranking score for a program based on the position of the program in a revision hierarchy. For example, the ranking module 112 can boost a final ranking score for an application if it is the latest revision in a chain of revisions.

The above-described supplemental ranking factors are cited by way of example, not limitation. Other environments can adopt yet additional types of supplemental ranking factors, and/or can omit one or more of the supplemental ranking factors described above. For example, another environment can adjust ranking scores based on sponsorship information. The sponsorship information identifies those individual end users and/or developers who have paid a fee (or otherwise established a right) to receive preferential ranking of their respective programs. The marketplace system 100 can also implement a bidding framework to identify the price that a sponsor is expected to pay to receive preferential ranking for his or her program.

The ordering module 602 can use any technique to combine different ranking factors together to produce a final ranking score for an application. In one case, the ordering module 602 can generate a final ranking score r_{f} as a weighted linear combination of different ranking factors f₁,f₂, . . . fₙ, as in r_{f}=w₁*f₁+w₂*f₂+ . . . wₙ*fₙ. In another case, the ordering module 602 can use a machine learning technique to learn a model that provides the final ranking score based on the different ranking factors described above.

In the above examples, the ordering module 602 may operate by organizing programs in a particular order, e.g., from most relevant to least relevant. In other cases, the ordering module 602 perform ordering in a more general sense by culling out and favoring certain programs, but without necessarily assigning a particular position to each program in a list. For instance, the ordering module 602 can choose a subset of the programs in the set of programs based on any of the supplemental ranking factors set forth above.

For example, the ordering module 602 can select a group of clusters that cover a prescribed range of topics. That is, assume that, based on some environment-specific consideration, the marketplace system 100 endeavors to present representative programs pertaining to each of topics A, B, C, D, and E for the user's consideration, e.g., so as to present a topically diverse selection of programs to the user. The ordering module 602 can first assess the subject matter of each cluster that is identified by the clustering module 308, e.g., by comparing sample programs from each cluster with reference programs of known classification. Then the ordering module 602 can select clusters which match the desired topics (if such clusters exist). The ordering module 602 can then pick representative programs from each cluster based on any consideration(s). In one approach, for instance, the ordering module 602 can perform this selection by calling on the removal module 604.

As to the removal module 604, this functionality can remove a program from consideration in various circumstances, based on one or more removal considerations. For example, consider the case in which the similarity analysis module 110 identifies a cluster having a relatively small number of similar programs, such as three. Each of these three programs will receive a relatively high rank because they originate from a small-sized cluster. In one implementation, the ranking module 112 can retain all three of these programs. But in another implementation, the ranking module 112 can omit one or more of these programs, under the assumption that one or more of these programs are redundant, and that the presentation of redundant programs may confuse and/or distract the user. In one case, the removal module 604 can remove one or more programs from the same cluster having the lowest ranking scores. For example, by removing all but the top-ranked program, this process can effectively choose a single representative program for each cluster. In one case, the removal module 604 can perform removal of a program in a cluster only if its degree of similarity to its same-cluster peers exceeds a prescribed threshold.

Alternatively, or in addition, the removal module 604 can remove programs based on revision information. For example, the removal module 604 can retain only the leaf nodes in a revision tree, omitting the remaining parent nodes. The removal module 604 can adopt this strategy based on the assumption that the child nodes represent the latest variations of a root program (associated with a root node of the revision tree), and that the latest variations are the most desirable. The removal module 604 can also balance this conclusion with respect to other removal considerations, such as rating information or usage information. For example, the removal module 604 can decline to remove a “parent” program if that program is highly rated by users and/or that program has been frequently downloaded by users.

This allows the marketplace 100 to test the viability of new revisions (corresponding to new child nodes) before recommending them to users.

More generally stated, in some implementations, the ordering module 602 can generate a list of ranked programs. The removal module 604 can then remove one or more programs from this list based on one or more removal considerations, to provide a final list of ranked programs. In other implementations, the removal module 604 can remove programs from an initial set of programs prior to the programs being ordered by the ordering module 602. Or the removal module 604 can perform removal as a standalone operation, that is, without the operation of the ordering module 602 (and vice versa). All these operations constitute instances of “ranking” as defined herein.

FIG. 7 depicts an example of the operation of the ordering module 602 and the removal module 604. In this case, the similarity analysis module 110 identifies n clusters. Each cluster contains two or more programs that are assessed as being similar to each other (although it is also possible to have one or more singlet clusters, each of which identifies a single program). Further, the ordering module 602 can optionally select a subset of clusters as particularly interesting, e.g., based on user profile information and/or program category information. The ordering module 602 can then call on the removal module 604 to select at least one representative program from each surviving cluster. FIG. 7 uses black stars to represent the selected representative programs.

FIG. 8 shows one illustrative user interface presentation 800 that the selection presentation module 114 (of FIG. 1) can present to the user when the user visits the marketplace system 100. This user interface presentation 800 is merely representative. The marketplace system 100 can present many other types of user interface presentations that take into account ranking information. Each user interface presentation can have its own functionality, look, feel, etc.

In the example of FIG. 8, the user interface presentation 800 includes a section 802 which presents program information associated with a subset of candidate programs. The user can further investigate and acquire any candidate program in this section 802. In one case, the selection presentation module 114 can order the programs in the section 802 based on the ranking information, e.g., by presenting the highest-ranking program at the top of the section 802 and the lowest-ranking program at the bottom of the section 802. Alternatively, or in addition, the selection presentation module 114 can use other strategies to convey the ranks of programs, such by presenting textual and graphical information which conveys ranking scores, adjusting the size and/or other visual attributes of program information based on the ranking scores, and so on.

In addition, although not shown in FIG. 8, the selection presentation module 114 can organize the candidate programs into different categories. For example, the selection presentation module 114 can identify the n highest-ranking programs in each of m identified categories.

Further, as described above, the marketplace system 100 can tailor the information that it presents to a particular user based on user profile information associated with that user. This means that a first user may receive information regarding a different subset of programs (and/or a different ordering of such programs) compared to a second user, depending on the different profiles associated with the two users.

Command prompt 804 invites the user to activate and de-activate the ranking function performed by the program selection module 106. Command prompt 806 allows the user the specify his or her preferences regarding the manner in which ranking is performed. That is, upon activation of the command prompt 806, the user configuration module 118 collects and persists the user's ranking-related preferences.

As stated above, the selection presentation module 114 can also present ranking information to a user via other modes of information transfer (that is, other than a dedicated user interface presentation).

B. Illustrative Processes

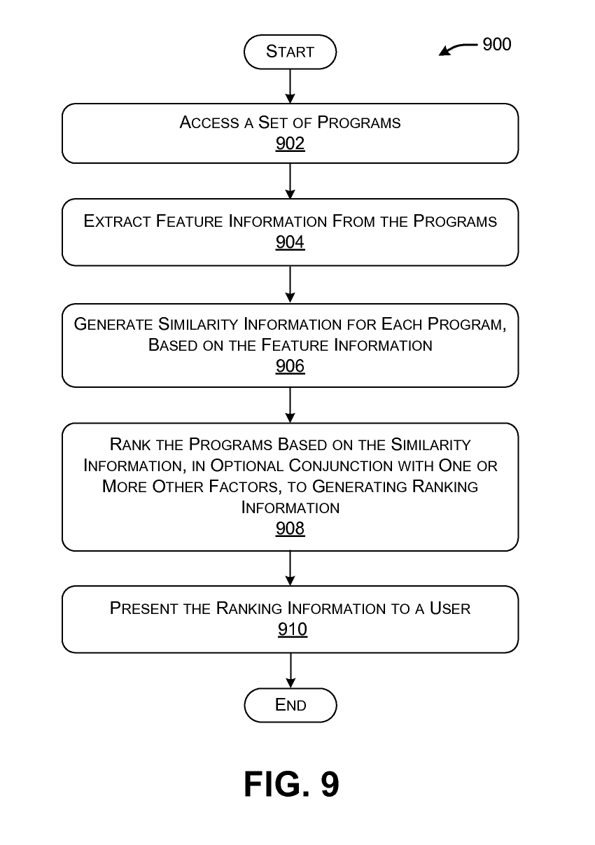

FIGS. 9-11 show procedures that explain one manner of operation of the marketplace 100 of FIG. 1. Since the principles underlying the operation of the marketplace system 100 have already been described in Section A, certain operations will be addressed in summary fashion in this section.

Starting with FIG. 9, this figure shows an illustrative procedure 900 that sets forth an overview of one manner of operation of the marketplace system 100 of FIG. 1. In block 902, the marketplace system accesses a set of programs. In block 904, the marketplace system 100 extracts feature information from each of the programs. In block 906, the marketplace system 100 generates similarity information for each program, based on the feature information. In block 908, the marketplace system 100 ranks the programs based at least on the similarity information, to provide ranking information. In block 910, the marketplace system 100 provides a user interface presentation (or some other communication) that highlights (e.g., promotes) at least one distinctive program in the set of programs, based on the ranking information. In other implementations, one or more operations of the procedure 900 can be omitted, such as the feature-extracting operation of block 904.

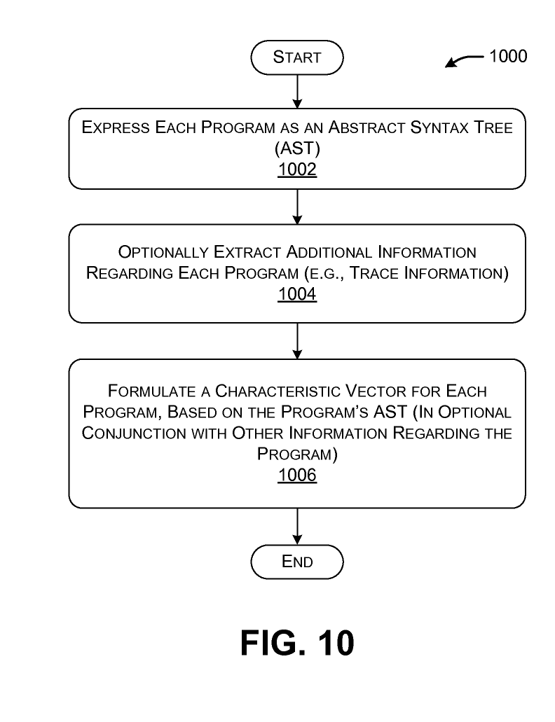

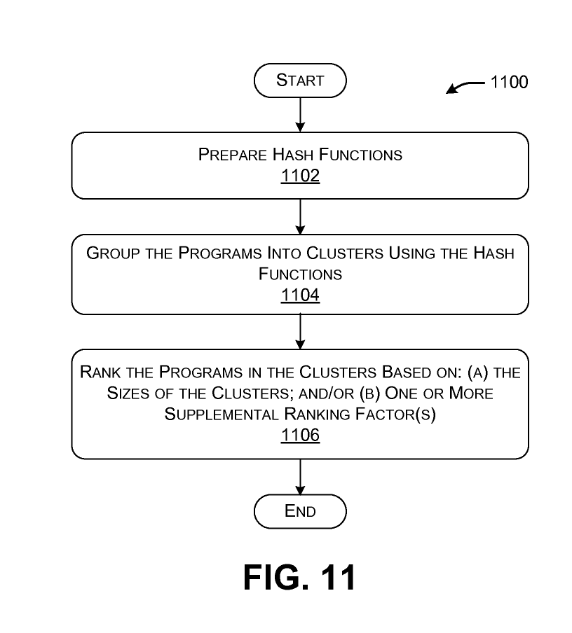

FIG. 11 shows a procedure 1000 that represents one manner of operation of the program formulation module 108 according to one particular (but non-limiting) implementation. In block 1002, the program formulation module 108 expresses each program as an abstract syntax tree (AST). In block 1004, the program formulation module 108 optionally extracts additional information from additional sources, such as trace information from a runtime system which runs each program. In block 1006, the program formulation module 108 formulates a characteristic vector which represents the features associated with each program. FIG. 4, as explained in Section A, graphically depicts the manner of operation of the procedure 1000 of FIG. 10.

FIG. 12 shows a procedure 1100 that represents one manner of operation of the similarity analysis module 110 and the ranking module 112 according to one particular (but non-limiting) LSH implementation. In block 1102, the similarity analysis module 110 prepares L k-component hash functions in the manner described in Section A. In block 1104, the similarity analysis module 110 groups of the programs into multiple sets of clusters using the k-component hash functions, e.g., by evaluating the characteristic vectors using the k-component hash functions, which has the effect of placing the characteristic vectors into appropriate bins (associated with respective clusters). This grouping of programs into clusters constitutes the generation of similarity information.

In block 1106, the ranking module 112 ranks the programs based on the similarity information in optional conjunction with one or more supplemental ranking factors. In one case, ranking may constitute placing the programs in a particular order. In addition, or alternatively, ranking may involve removing one or more programs based on one or more removal considerations.

C. Representative Computing Functionality

FIG. 12 sets forth illustrative computing functionality 1200 that can be used to implement any aspect of the functions described above. For example, the computing functionality 1200 can be used to implement any aspect of the marketplace system 100 of FIGS. 1 and 2, and/or any aspect of any user computing device that is used to interact with the marketplace system 100. In one case, the computing functionality 1200 may correspond to any type of computing device that includes one or more processing devices. In all cases, the computing functionality 1200 represents one or more physical and tangible processing mechanisms.

The computing functionality 1200 can include volatile and non-volatile memory, such as RAM 1202 and ROM 1204, as well as one or more processing devices 1206 (e.g., one or more CPUs, and/or one or more GPUs, etc.). The computing functionality 1200 also optionally includes various media devices 1208, such as a hard disk module, an optical disk module, and so forth. The computing functionality 1200 can perform various operations identified above when the processing device(s) 1206 executes instructions that are maintained by memory (e.g., RAM 1202, ROM 1204, or elsewhere).

More generally, instructions and other information can be stored on any computer readable medium 1210, including, but not limited to, static memory storage devices, magnetic storage devices, optical storage devices, and so on. The term computer readable medium also encompasses plural storage devices. In all cases, the computer readable medium 1210 represents some form of physical and tangible entity.

The computing functionality 1200 also includes an input/output module 1212 for receiving various inputs (via input modules 1214), and for providing various outputs (via output modules). One particular output mechanism may include a presentation module 1216 and an associated graphical user interface (GUI) 1218. The computing functionality 1200 can also include one or more network interfaces 1220 for exchanging data with other devices via one or more communication conduits 1222. One or more communication buses 1224 communicatively couple the above-described components together.

The communication conduit(s) 1222 can be implemented in any manner, e.g., by a local area network, a wide area network (e.g., the Internet), etc., or any combination thereof. As noted above in Section A, the communication conduit(s) 1222 can include any combination of hardwired links, wireless links, routers, gateway functionality, name servers, etc., governed by any protocol or combination of protocols.

Alternatively, or in addition, any of the functions described in Sections A and B can be performed, at least in part, by one or more hardware logic components. For example, without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

In closing, functionality described herein can employ various mechanisms to ensure the privacy of user data maintained by the functionality. For example, the functionality can allow a user to expressly opt in to (and then expressly opt out of) the provisions of the functionality. The functionality can also provide suitable security mechanisms to ensure the privacy of the user data (such as data-sanitizing mechanisms, encryption mechanisms, password-protection mechanisms, etc.).

Further, the description may have described various concepts in the context of illustrative challenges or problems. This manner of explanation does not constitute an admission that others have appreciated and/or articulated the challenges or problems in the manner specified herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, performed by computing functionality, for ranking programs accessible via a marketplace system, comprising:
accessing a set of programs in the marketplace system;
dynamically extracting trace information during execution of each program;
generating similarity information for each program that reflects a relative distinctiveness of each program with respect to other programs in the set of programs based on the dynamically extracted trace information;
ranking the programs based at least on the similarity information, to provide ranking information; and
providing the ranking information to a user.

2. The method of claim 1, wherein at least a subset of the set of programs are authored by modifying pre-existing programs.

3. The method of claim 1, wherein said extracting trace information comprises:
expressing each program as an abstract syntax tree; and
formulating a characteristic vector for each program, the characteristic vector characterizing features within the abstract syntax tree.

4. The method of claim 3, wherein the characteristic vector, for each program, has respective components, each component identifying a prevalence of a particular feature within the abstract syntax tree.

5. (canceled)

6. The method of claim 3, wherein said generating of similarity information comprises assessing similarity between programs in the set of programs by assessing similarity between corresponding characteristic vectors associated with the programs.

7. The method of claim 1, wherein said generating of similarity information comprises grouping the set of programs into a plurality of clusters, each plural-membered cluster having two or more programs that are assessed as being similar to each other.

8. The method of claim 7, wherein said grouping uses a locality sensitive hashing technique.

9. The method of claim 7, wherein said ranking comprises assigning a ranking score to each of the programs in the set of programs, the ranking score being based, at least in part, on a size of a cluster to which each program belongs.

10. The method of claim 9, wherein the ranking score of the program becomes more favorable as the cluster, to which the program belongs, decreases in size.

11. The method of claim 1, wherein the ranking information also depends on rating information, the rating information conveying a rating of each program assigned by one or more users.

12. The method of claim 1, wherein the ranking information also depends on usage information, the usage information conveying a degree of utilization of each program by one or more users.

13. The method of claim 1, wherein the ranking information depends on user profile information, the user profile information identifying program-related preferences of one or more users.

14. The method of claim 1, wherein the ranking information also depends on program category information, the program category information identifying a category of each program.

15. The method of claim 1, wherein the ranking information also depends on revision information, the revision information identifying respective positions of programs in revision hierarchies.

16. The method of claim 1, further comprising removing at least one program in the set of programs based on at least one removal consideration, said removing causing the marketplace system to omit said at least one program in the user interface presentation.

17. (canceled)

18. (canceled)

19. A computer readable storage medium for storing computer readable instructions, the computer readable instructions providing a program selection module when executed by one or more processing devices, the computer readable instructions comprising:
logic configured to access a set of programs;
logic configured to express each program as an abstract syntax tree; and
logic configured to formulate a characteristic vector for each program, the characteristic vector characterizing features within a corresponding abstract syntax tree;
logic configured to group the programs in the set of programs into a plurality of clusters based on characteristic vectors associated with the programs, each plural-membered cluster having two or more programs that are assessed as being similar to each other;
logic configured to order the programs in the set of programs to generate ranking information, based at least on:
a size of each cluster to which each program belongs; and
at least one supplemental ranking factor, the at the least one supplemental ranking factor generated using trace information extracted during execution of each program;
logic configured to present the ranking information to a user.

20. (canceled)

21. The computer readable storage medium of claim 19, wherein the trace information includes a rating of each program assigned by one or more users.

22. The computer readable storage medium of claim 19, wherein the trace information includes usage information conveying a degree of utilization of each program by one or more users.

23. The computer readable storage medium of claim 19, wherein the trace information includes user profile information identifying program-related preferences of one or more users.
